(19) United States
(12) Patent Application Publication
(10) Pub. No.: US 2003/0070162 A1
(43) Pub. Date: Apr. 10, 2003

(54) Information processor having multi OS and its OS update method

(76) Inventors: Satoshi Oshima, Tachikawa (JP); Shinji Kimura, Sagamihara (JP); Toshiaki Arai, Machida (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 10/261,686

(22) Filed: Oct. 2, 2002

(30) Foreign Application Priority Data
Oct. 4, 2001 (JP) 2001-308156

(51) Int. Cl. G06F 9/44; G06F 9/445

(52) U.S. Cl. 717/171; 717/176

(57) ABSTRACT

The present invention provides an art that can update an OS (Operating System) of an information processor efficiently. An OS update method that updates the OS installed in the information processor has the steps of determining whether an update of a front end OS that controls usual application processing is necessary, terminating the processing of the front end OS in operation and switching the control of the information processor to a back end OS, acquiring update data for updating the front end OS in the latest state under the control of the back end OS when it is determined that the update of the front OS is necessary, updating the front end OS in the latest state, and restarting the updated front end OS in the latest state.

### BACKGROUND OF THE INVENTION

1. Field of the Invention

The present invention relates to an information processor that updates an operating system (OS), implements security in accordance with a management policy, and performs the remote maintenance of the management policy, and, more particularly, to an effective art applied to the information processor that provides an update function, a security function, and a remote maintenance function of the OS by installing multiple OSs.

2. Description of the Prior Art

With rapid progress of a portable terminal unit such as a cellular phone in recent years, various functions, such as accessing the Internet, downloading and reproducing music data, and photographing a photo of a user and sending it as electronic mail, are provided by the portable terminal unit.

Such a portable terminal unit provides all sorts of functions by storing an OS, a built-in application program (built-in AP), and a user application program (user AP) or data accessed by their processing in a nonvolatile memory inside the portable terminal unit and starting a program on the nonvolatile memory when power is turned on or the terminal is operated by a user.

The conventional portable terminal unit must update the program on the nonvolatile memory to add a new function or modify an existing program. To update the program on the nonvolatile memory inside the portable terminal unit, however, the portable terminal unit is connected to a dedicated information processor such as a personal computer (PC) and the contents of the nonvolatile memory inside the portable terminal unit must be rewritten by the operation of the information processor. Because it is difficult for a general user to perform this work, the user delivers the portable terminal unit body to a service center to rewrites a program. Further, the portable terminal unit supplier bears the expenses for the process.

On the other hand, among portable terminal units whose high performance and multi functions are being achieved, ones that can download and execute a user AP are increasing. In the execution of application processing, however, a security setting such as whether the information inside the portable terminal unit can be accessed or whether communication with an external device is enabled, is all performed in a common carrier company that provides the portable terminal unit.

For example, a common carrier that performs services for general consumers restricts an application that can access the information inside the portable terminal unit and external information simultaneously to only the application provided by the common carrier itself in order to prevent address lists in the terminal from leaking out.

A program update device and a program update method that update part of program block data of program data consisting of multiple program blocks stored in a flash memory are described in Japanese Patent Laid-open No. Hei-12 (2000)-242487. The outline is as follows. In regard to the flash memory that stores multiple block programs for implementing functions A to E, for example, to update the function-D OS data, before the fourth memory block data is deleted, the data of part of the function-C OS data and part of the function-E data of the OS data stored in the fourth memory block together with the function-D OS data are stored temporarily in a personal computer. After the fourth memory block data is deleted, the saved data is written to the original position of the fourth memory block together with new function-D OS data.

In the conventional portable terminal unit, because it is difficult for a user to update an OS and a built-in AP as well as the user must deliver the portable terminal unit body to a service center rewrite a program, considerable time and expenses are required in the OS and built-in AP update work. Because occurrences of bugs are expected to increase still more with the attainment of an improved-function and high-performance portable terminal unit, the update problem of this program must be solved.

On the other hand, in the case of portable terminal units whose high performance and multi functions are being achieved, although it is anticipated in the future that high-performance and multi-function portable terminal units advance into the business world as shown in the current PC, the security of the portable terminal units under the present conditions is all set in a common carrier that provides the portable terminal units. Accordingly, when an enterprise utilizes this, there is a problem that even its own business applications cannot determine the accessibility of an application based on a standard that differs from that of the common carrier when, for example, an attempt is made to access the information inside and outside the portable terminal unit.

Further, in the conventional portable terminal unit, even if a common carrier sets the information about the accessibility in accordance with requests of an enterprise, such information as the accessibility of the application created once is stored in a nonvolatile memory of the portable terminal unit. Because an effective means such as remote maintenance that updates this information is not provided, the portable terminal unit is withdrawn whenever a business application function is changed in accordance with a change of contents of business and the business application and the corresponding security information must be updated using a dedicated device. Considerable time and expenses are required in the maintenance of the business application and the security information.

### SUMMARY OF THE INVENTION

An object of the present invention is to provide an art that solves the aforementioned problems and can update an OS of an information processor efficiently.

Another object of the present invention is to provide an art that can implement, by the information processor, a security function based on a standard unique to the user.

A further object of the present invention is to provide an art that enables the remote maintenance of the security function inside the information processor.

The present invention updates a front end OS (operating system) under the control of a back end OS when it is determined that the front end OS must be updated in an information processor that updates an OS installed in the information processor.

The present invention accesses a management processor from the information processor that is a portable terminal unit such as a cellular phone, acquires the update information of the front end OS that controls usual application processing from the management processor, compares the management information of the front end OS installed in the information processor with the acquired update information, and determines whether the front end OS installed in the information processor must be updated.

If it is determined that the front end OS must be updated, the processing of a multi OS configuration part enables the operation of the information processor under the control of the back end OS by terminating the processing of the front end OS in operation and switching the control of each unit inside the information processor. Subsequently, the management processor is accessed via a network, the update data for updating the front end OS in the latest state is acquired from the management processor under the control of the back end OS, and the front end OS is updated in the latest state.

Further, after the front end OS updated in the latest state is restarted, the control of each unit inside the information processor is switched to the front end OS after the update and the operation of the information processor is enabled by the control of the front end OS after the update.

As described above, according to the information processor of the present invention, if it is determined that the front end OS must be updated, the OS of the information processor can be updated efficiently because the front end OS is updated under the control of the back end OS.

### BRIEF DESCRIPTION OF THE DRAWINGS

Preferred embodiments of the present invention will be described in detail based on the followings, wherein:

FIG. 1 is a drawing showing a schematic configuration of a portable terminal unit multi OS system according to this embodiment;

FIG. 2 is a flowchart showing a processing procedure of front end OS up-data (update data) 122 according to this embodiment;

FIG. 3 is a drawing showing an example of an update information management table 142 according to this embodiment;

FIG. 4 is a flowchart showing a processing procedure of a security agent 112 according to this embodiment;

FIG. 5 is a flowchart showing a processing procedure of a security check processor 124 according to this embodiment;

FIG. 6 is a drawing showing a management policy 126 according to this embodiment; and

FIG. 7 is a flowchart showing a processing procedure of management policy up-data 125 according to this embodiment.

### DETAILED DESCRIPTION OF PREFERRED EMBODIMENTS

One embodiment of an information processor that provides an OS update function, a security function, and a remote maintenance function by installing multiple OSs is described below.

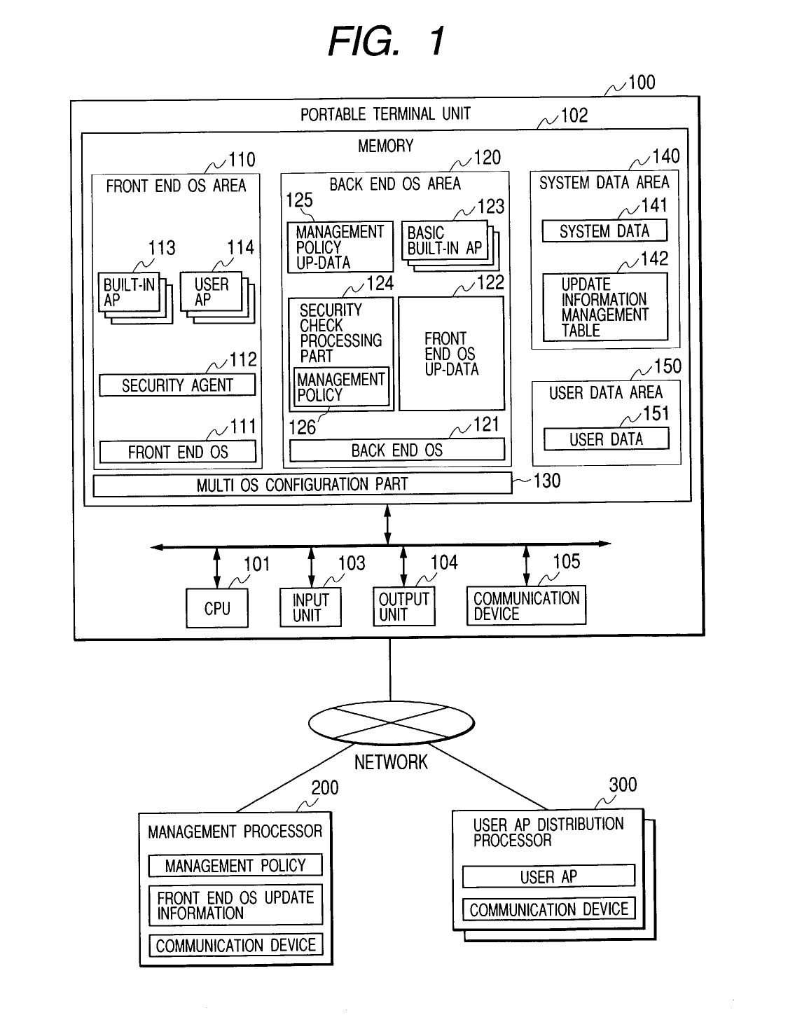

FIG. 1 is a drawing showing a schematic configuration of a portable terminal unit multi OS system according to this embodiment. As in FIG. 1, the portable terminal unit multi OS system of this embodiment has a portable terminal unit 100, a management processor 200, and a user AP distribution processor 300.

The portable terminal unit 100 is a portable type information processor such as a cellular phone that acquires front end OS update information and a management policy from the management processor 200 and implements the OS update function, the security function, and the remote maintenance function.

The management processor 200 provides the portable terminal unit 100 with the latest information about the front end OS update information and the management policy. The user AP distribution processor 300 distributes a user AP to the portable terminal unit 100 in accordance with a request from the portable terminal unit 100.

The portable terminal unit 100 has a CPU 101, a memory 102, an input unit 103, an output unit 104, a communication device 105, a front end OS area 110, a back end OS area 120, a management policy 126, a system data area 140, system data 141, an update information management table 142, a user data area 150, and user data 151.

The CPU 101 controls the overall operation of the portable terminal unit 100. The memory 102 is a nonvolatile memory device such as a flash memory that loads various processing programs and data used for controlling the overall operation of the portable terminal unit 100.

The input unit 103 performs various inputs for operating the portable terminal unit 100. The output unit 104 performs various outputs accompanying the operation of the portable terminal unit 100. The communication device 105 communicates with other processors via a network, such as the Internet or intranet, and performs a voice call.

The front end OS area 110 stores a front end OS 111 and various programs that operate under its control. The back end OS area 120 stores a back end OS 121 and various programs that operate under its control. The management policy 126 is data indicating the contents of application processing whose execution is permitted on the portable terminal unit 100.

The system data area 140 stores the system data 141. The system data 141 is used for operating system programs such as the front end OS 111, the back end OS 121, and the multi OS configuration part 130. The update information management table 142 stores the update information of the front end OS 111 and a built-in AP 113.

The user data area 150 stores the user data 151. The user data 151 is directory data and schedule data acquired or created by application processing of a user AP 114.

Further, the portable terminal unit 100 has the front end OS 111, a security agent 112, the built-in AP 113, the user AP 114, the back end OS 121, front end OS up-data (update data) 122, a basic built-in AP 123, a security check processing part 124, a management policy up-data 125, and the multi OS configuration part 130.

The front end OS 111 controls usual application processing such as the built-in AP 113 and the user AP 114. The security agent 112 is a processing part that sends to the security check processing part 124 an inquiry as to whether the application processing request is permitted if an application processing request is made on the portable terminal unit 100, and executes the application processing when the contents of the inquiry result indicate the execution permission of the application processing.

The built-in AP 113 is a processing part that executes predetermined application processing such as directory edit processing incorporated in the front end OS 111. The user AP 114 is a processing part that executes predetermined application processing such as estimate processing distributed from a user AP distribution processor 300.

The back end OS 121 controls the operation of the portable terminal unit 100 while the front end OS 111 is stopped and operates in response to a processing request from the security agent 112 in security check processing.

The front end OS up-data 122 is a processing part that determines whether the front end OS 111 that controls the usual application processing must be updated, acquires update data for updating the front end OS 111 to the latest state, and updates the front end OS 111 to the latest state.

The basic built-in AP 123 is the minimum necessary subset for operating in the built-in AP 113 as a cellular phone as well as it is a processing part that contains, for example, if a directory AP, a receiving melody creation AP, and a game AP are provided in the built-in AP 113, only the directory AP from which browsing and only a browsing-based telephone call can be performed and space in which the bug enters the back end OS 121 is reduced as much as possible.

The security check processing part 124 determines whether the inquired processing request is permitted in accordance with the management policy 126 and subsequently responds to the security agent 112 with an inquiry result that indicates the contents of the determination. The management policy up-data 125 is a processing part that updates the management policy 126 inside the portable terminal unit 100 in accordance with the contents of the management policy stored in the management processor 200.

The multi OS configuration part 130 is a processing part that operates the front end OS 111 and the back end OS 121 in a time slice and controls the communication between the security agent 112 on the front end OS 111 and the security check processing part 124 on the back end OS 121. If it is determined that the front end OS 111 must be updated, the processing part terminates the processing of the front end OS 111 in operation, switches the control of the portable terminal unit 100 to the back end OS 121, and restarts the front end OS 111 updated in the latest state.

A program for making the portable terminal unit 100 function as the front end OS 111, the security agent 112, the built-in AP 113, the user AP 114, the back end OS 121, the front end OS up-data 122, the basic built-in AP 123, the security check processing part 124, the management policy up-data 125, and the multi OS configuration part 130 is recorded in a recording medium such as a flash memory and executed. The recording medium that records the program can be a recording medium other than the flash memory. Further, the program can also be used by being installed in an information processor from the recording medium or by accessing the recording medium via a network.

The portable terminal unit 100 of this embodiment has a multi OS configuration in which the front end OS 111 that controls the usual application processing of the built-in AP 113 or the user AP 114 and the back end OS 121 that controls the operation of the portable terminal unit 100 while the front end OS 111 is stopped operate in a time slice. The latest OS provided with an excellent GUI (Graphical User Interface) as the front end OS 111 is installed and the portable terminal unit 100 operates using an OS of the previous version whose operation is stable as the back end OS 121. Hereupon, another OS known to operate stably or an OS made stable by significantly restricting functions even in the same version can also be used as the back end OS 121.

To add a new function to the front end OS 111 or correct a newly detected defect of the front end OS 111, the multi OS configuration part 130 assigns the input unit 103, the output unit 104, and the communication device 105 of the portable terminal unit 100 from the front end OS 111 to the back end OS 121 and operates them, and updates the front end OS 111 under the control of the back end OS 121. Hereupon, the multi OS configuration part 130 switches the front end OS 111 to the back end OS 121 by mapping I/O processing interrupt mapped in the front end OS 111 to the back end OS 121.

In the portable terminal unit multi OS system of this embodiment, the processing of operating the front end OS up-data 122 under the control of the back end OS 121, downloading update data via a network, executing update processing, and updating the front end OS 111 and the built-in AP 113 is described below.

FIG. 2 is a flowchart showing a processing procedure of the front end OS up-data 122 of this embodiment. As shown in FIG. 2, the front end OS up-data 122 of the portable terminal unit 100 of this embodiment determines whether the front end OS 111 that controls the usual application processing must be updated, acquires, under the control of the back end OS 121, update data for updating the front end OS 111 in the latest state, and updates the front end OS 111 in the latest state.

In step 201, the front end OS up-data 122 of the portable terminal unit 100 checks whether a predetermined condition under which the update processing of the front end OS 111 starts is satisfied such as when predetermined time elapses from the previous processing or a specific key is pressed by the user, and processing goes to step 202 when the condition is satisfied.

In the step 202, the contents of the update information management table 142 that stores various information of the front end OS 111 and the built-in AP 113 installed in the portable terminal unit 100 are read.

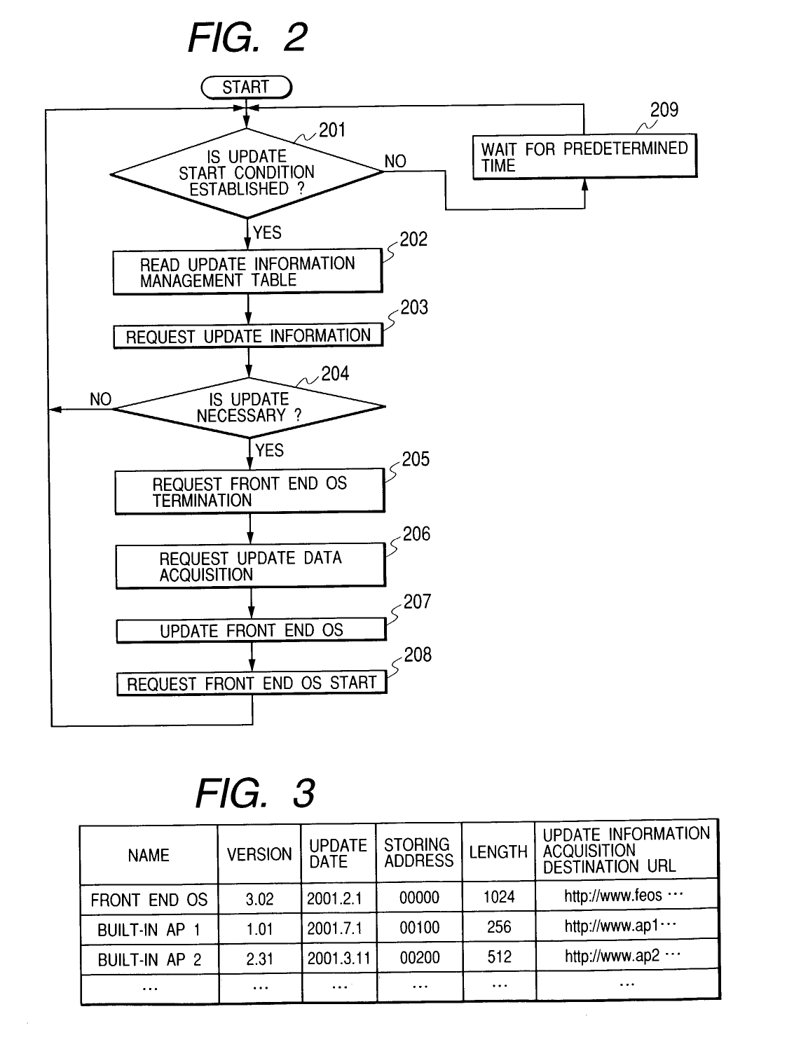

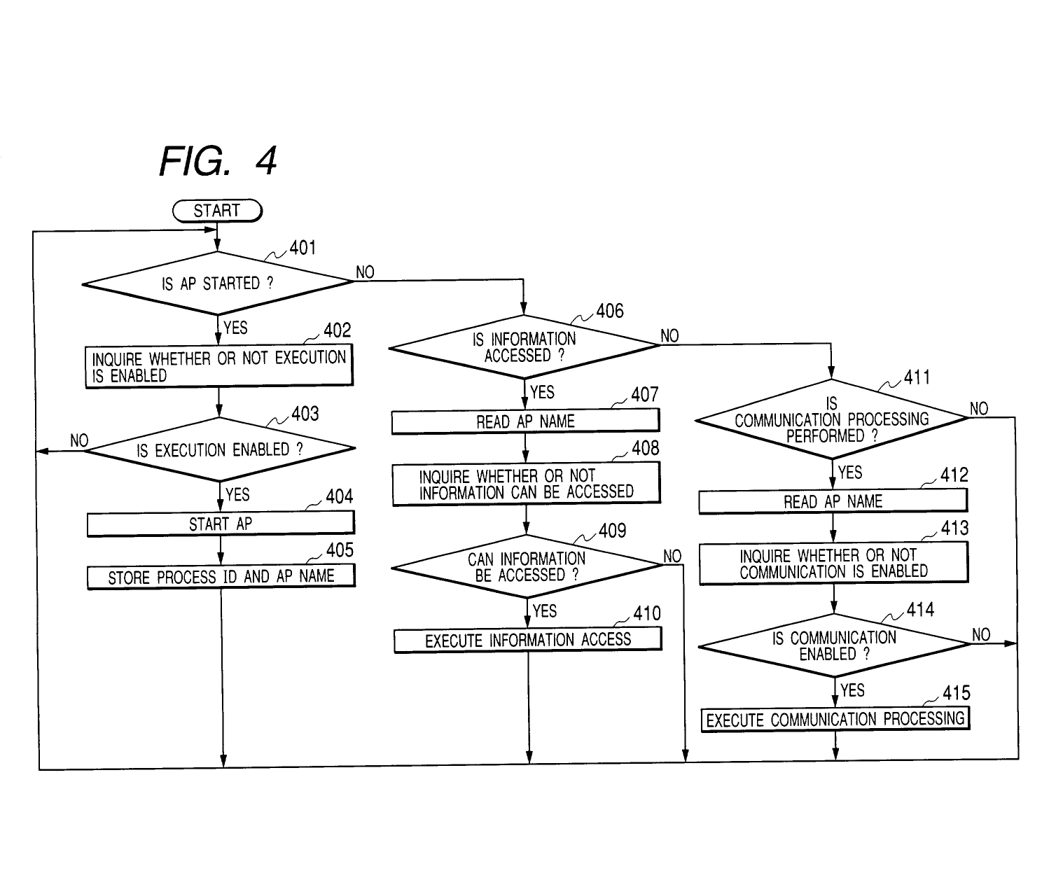

FIG. 3 shows a drawing showing an example of the update information management table 142 of this embodiment. As shown in FIG. 3, the update information management table 142 of this embodiment stores versions of the front end OS 111 and the built-in AP 113 stored in the front end OS area 110, an update date indicating a date when the front end OS 111 and the built-in AP 113 were stored in the front end OS area 110, an address and its length stored in the front end OS area 110, and stores an update information acquisition destination URL (Uniform Resource Locator) indicating the address of the management processor 200 that provides the update information of the front end OS 111 and the built-in AP 113.

In step 203, the front end OS up-data 122 accesses the address of the management processor 200 indicated in the update information acquisition destination URL of the read update information management table 142 and requests the management processor 200 for the sending of the update information of the front end OS 111 and the built-in AP 113.

At the request of this update information, if the communication device 105 is assigned to the front end OS 111 but is not assigned to the back end OS 121, a connection switching request of the communication device 105 from the front end OS 111 to the back end OS 121 is made to the multi OS configuration part 130. It can also be considered acceptable that the back end OS 121 always performs communication processing by adopting an OS that is excellent in real time processing as the back end OS 121.

The management processor 200, when it receives update information acquisition requests of the front end OS 111 and the built-in AP 113 from the portable terminal unit 100, reads the front end OS update information stored in the management processor 200 and sends it to the portable terminal unit 100. Hereupon, the latest versions and update dates of the front end OS 111 and the built-in AP 113 are stored as the front end OS update information of the management processor 200.

When the front end OS up-data 122 of the portable terminal unit 100 receives the front end OS update information from the management processor 200, processing goes to step 204 and compares the versions and update dates of the front end OS 111 and the built-in AP 113 stored in the update information management table 142 with the version and update date in the front end OS update information received from the management processor 200. If the version and update date stored in the update information management table 142 are older, processing goes to step 205 assuming update processing to be necessary.

In the step 205, the multi OS configuration part 130 is called via the back end OS 121 and the termination of the front end OS 111 and the built-in AP 113 is requested to the multi OS configuration part 130.

When the multi OS configuration part 130 receives termination requests of the front end OS 111 and the built-in AP 113 from the front end OS up-data 122, the part terminates the processing of the front end OS 111 and the built-in AP 113 in operation. Subsequently, the part assigns resources such as the input unit 103, the output unit 104, and the communication device 105 to the back end OS 121 and switches the control of the portable terminal unit 100 to the back end OS 121.

Hereupon, if an application processing execution request is input from the user, the minimum necessary processing is performed by operating the basic built-in AP 123 via the back end OS 121 even while the front end OS 111 is being updated.

Further, because the system data 141 and the user data 151 are stored in the system data area 140 and the user data area 150 that differ from the front end OS area 110, the back end OS 121 and the basic built-in AP 123 that provide the minimum necessary processing can provide the user with the same processing as the front end OS 111 and the built-in AP 113 making use of the system data 141 and the user data 151 used in the front end OS 111 as they are.

In step 206, the front end OS up-data 122 accesses the address of the management processor 200 indicated in the update information acquisition destination URL of the read update information management table 142 and requests the management processor 200 for the sending of the update data for updating the front end OS 111 and the built-in AP 113 to the latest state.

Hereupon, the update data can be any of an installation program, difference data or the latest front end OS 111 and the built-in AP 113 themselves for updating the front end OS 111 and the built-in AP 113 to the latest state.

In step 207, the front end OS up-data 122 receives update data sent from the management processor 200 and updates the front end OS 111 and the built-in AP 113 stored in the area indicated in a storing address and length inside the update information management table 142 to the latest state. Subsequently, the up-data updates the information about the version and the update date inside the update information management table 142 to new contents.

In step 208, the multi OS configuration part 130 is called via the back end OS 121 and the restart of the front end OS 111 and the built-in AP 113 is instructed.

When the multi OS configuration part 130 receives restart instructions of the front end OS 111 and the built-in AP 113 from the front end OS up-data 122, the part restarts the front end OS 111 and the built-in AP 113 after the update. Subsequently, the part assigns the resources such as the input unit 103, the output unit 104, and the communication device 105 to the front end OS 111 and switches the control of the portable terminal unit 100 to the front end OS 111.

Because the conventional portable terminal unit operates by executing an OS or a built-in AP stored in a nonvolatile memory, the operation of the OS or the built-in AP to be updated must be stopped to update the OS or the built-in AP. Because the single portable terminal unit cannot operate if the OS stops, a program must be rewritten by delivering the portable terminal unit body to a service center and connecting it to a dedicated device.

On the contrary, after the portable terminal unit multi OS system of this embodiment stops the front end OS 111 and the built-in AP 113 to be updated, the system transfers the control of the portable terminal unit 100 to the back end OS 121 and operates the front end OS up-data 122 under the control of the back end OS 121. Accordingly, update processing is executed by downloading update data via a network and the front end OS 111 and the built-in AP 113 can be updated on line.

In this embodiment, the processing of updating the front end OS 111 and the built-in AP 113 in the portable terminal unit 100 that stores an OS and a built-in AP in a nonvolatile memory is described. The OS and the built-in AP stored in a magnetic disc drive can also be applied to an information processor such as a PC that loads them on the memory and executes them.

The conventional information processor updates a program manually using a portable type recording medium such as a CD-ROM. Because this embodiment performs update processing on line via a network, the update processing can be performed efficiently without manual operation.

Further, it is also considered that the conventional information processor performs the update processing by acquiring the contents of the recording medium for update processing via the network. When the update processing is performed to correct a defect of an OS or a built-in AP, however, communication processing is performed under single OS environment using the OS or the built-in AP that contains the defect. Accordingly, the communication processing cannot be executed normally due to the defect and the update processing may not be performed.

On the contrary, because this embodiment stops the front end OS 111 and the built-in AP 113 that contain a defect and performs the update processing under the control of the back end OS 121 whose operation is stable, the update processing can be performed efficiently without being affected by the defect to be updated.

Next, in the portable terminal unit multi OS system of this embodiment, the processing of implementing the security function that conforms to the management policy 126 inside the back end OS area 120 is described.

FIG. 4 is a flowchart showing a processing procedure of the security agent 112 of this embodiment. As shown in FIG. 4, the security agent 112 of this embodiment sends to the security check processing part 124 an inquiry as to whether an application processing request is permitted when the application processing request is made on the portable terminal unit 100, and executes the application processing when the contents of the inquiry result indicate the execution permission of the application processing.

Instep 401, the security agent 112 of the portable terminal unit 100 checks the contents of the application processing request performed on the portable terminal unit 100 and processing goes to the step 402 when the processing request is an application processing start request.

In the step 402, a name of an application under which the start request is made is specified and an inquiry as to whether the execution of the application processing is permitted is sent to the security check processing part 124 via the front end OS 111, the multi OS configuration part 130, and the back end OS 121.

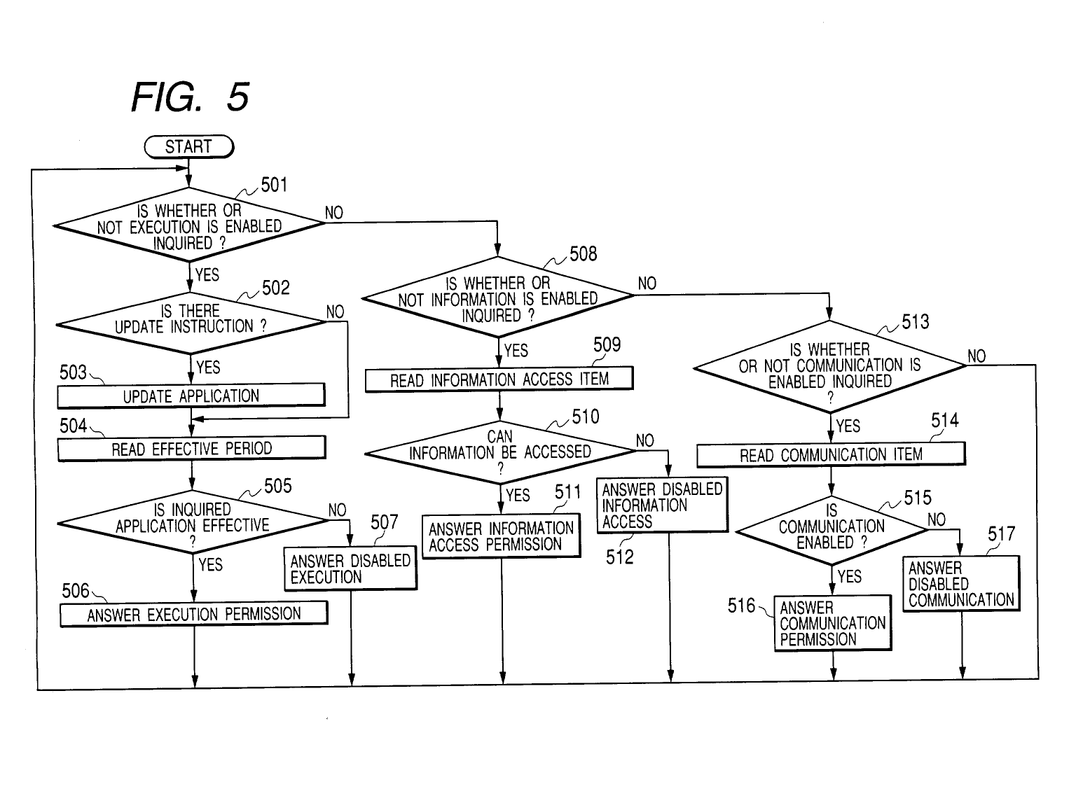

FIG. 5 is a flowchart showing a processing procedure of the security check processing part 124 of this embodiment. As shown in FIG. 5, the security check processing part 124 of this embodiment determines whether a processing request inquired from the security agent 112 is permitted in accordance with the management policy 126 and subsequently responds to the security agent 112 with an inquiry result that indicates the contents of the determination.

In step 501, the security check processing part 124 of the portable terminal unit 100 checks the contents of the inquiry from the security agent 112 and processing goes to step 502 when the contents of the inquiry are an inquiry as to whether the execution of the application processing is permitted.

In the step 502, the contents of an update instruction are read from a record of an AP name that matches a name of an application specified in the course of the inquiry referring to the management policy 126, and whether there is an update instruction of this application is checked. Processing goes to step 503 when the contents of the update instruction are “Present” and indicate that the update instruction is provided.

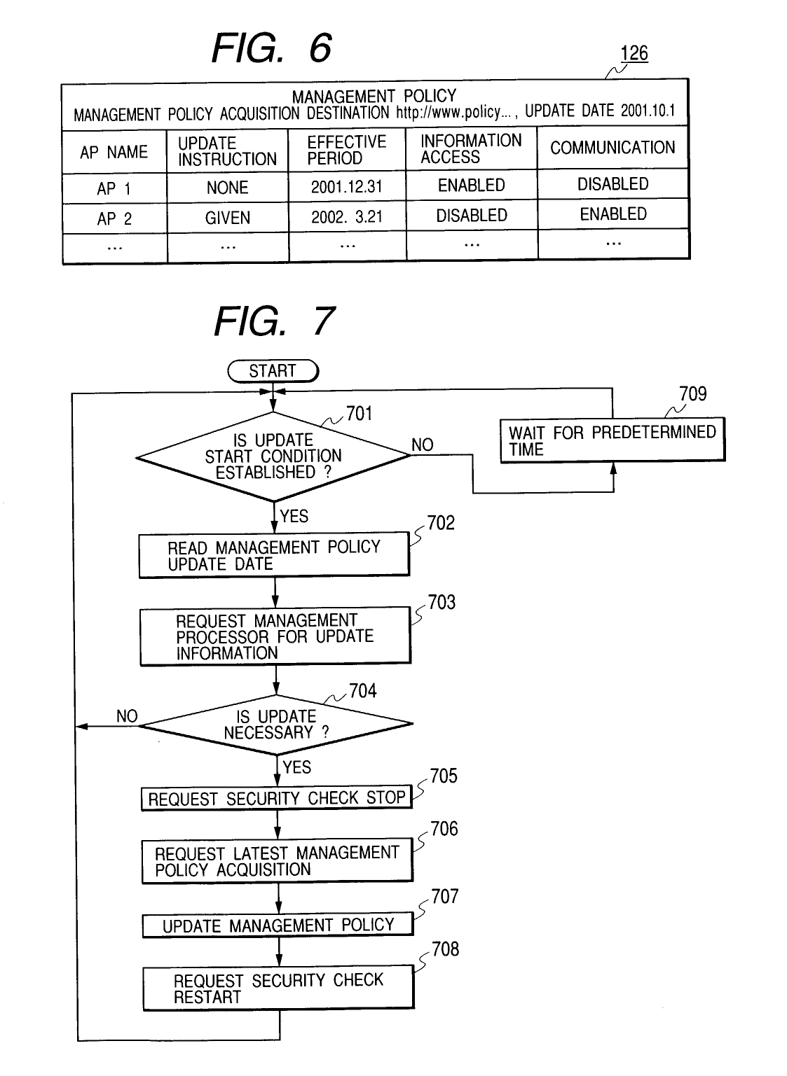

FIG. 6 is a drawing showing an example of the management policy 126 of this embodiment. As shown in FIG. 6, the management policy 126 of this embodiment has a management policy acquisition destination URL that indicates the URL of the latest management policy acquisition destination, an update date that indicates a date when the management policy 126 was updated previously, an item of an AP name that indicates a name of application processing checked by the security check processing part 124, an update instruction that indicates whether the update of the application is instructed, an effective period that indicates a period when the execution of the application processing is permitted, an item of information access that indicates whether access to the information inside the portable terminal unit 100 by the application processing is permitted, and an item of communication that indicates whether communication processing with an external device by the application processing is permitted.

In the step 503, reference is made to the management policy 126 to read the update processing of the user AP 114 is performed by accessing the user AP distribution processor 300 and acquiring the latest version of the inquired application from the user AP distribution processor 300 and the contents of the record update instruction inside the management policy 126 are changed to “None”.

In step 504, the effective period is read from a record of an AP name that matches a name of an application specified in the course of the inquiry.

In step 505, the effective period read from the management policy 126 and the current date are compared and processing goes to step 506 when the current date is within the effective period and the inquired application is effective. An inquiry result indicating that the execution of the application processing is permitted is sent to the security agent 112 via the back end OS 121, the multi OS configuration part 130, and the front end OS 111.

Further, in the step 505, as a result of comparing the effective period with the current date of the management policy 126, processing goes to step 507 when the effective period has expired as of the current date and the inquired application is not effective. Subsequently, this processing sends an inquiry result indicating that the execution of the application processing is not permitted to the security agent 112 via the back end OS 121, the multi OS configuration part 130, and the front end OS 111.

Instep 403, when the security agent 112 refers to an inquiry result returned from the security check processing part 124 and receives the inquiry result indicating the execution of the application processing is permitted, processing goes to the step 404. In other cases, a message indicating that the execution is not permitted is output to the output unit 104.

In the step 404, the application is started by making a start request of the application processing to the front end OS 111 and a process ID that is identification information for identifying a process of the started application is acquired from the front end OS 111.

In step 405, the process ID acquired from the front end OS 111 and the name of the application to which the start request was made are associated and stored in the memory 102.

On the other hand, as a result of checking the contents of an application processing request in the step 401, processing goes to the step 406 when the processing request is not an application processing start request.

In the step 406, it is checked whether the contents of the application processing request made on the portable terminal unit 100 are access to information such as directory data or schedule data stored in the user data area 150 inside the portable terminal unit 100. If the access to the information is assumed, processing goes to step 407.

In the step 407, a process ID of the application processing to the processing request was made is acquired and a name of an application that corresponds to the process ID is read from the process ID and the information about the application name stored in the memory 102.

In step 408, the name of the read application is specified and an inquiry as to whether the access to the information in the portable terminal unit 100 by the application processing is permitted is sent to the security check processing part 124 via the front end OS 111, the multi OS configuration part 130, and the back end OS 121.

In the step 501, the security check processing part 124 checks the contents of an inquiry from the security agent 112, and when the contents of the inquiry are not an inquiry as to whether the execution of application processing is permitted, processing goes to step 508.

In the step 508, the contents of the inquiry from the security agent 112 are checked, and when the contents of the inquiry are an inquiry as to whether the access to the information inside the portable terminal unit 100 by the application processing is permitted, processing goes to step 509.

In the step 509, an item of information access is read from a record of an AP name that matches a name of an application specified in the course of the inquiry referring to the management policy 126.

In step 510, when the contents of the information access item read from the management policy 126 are referred to and the access to the information inside the portable terminal unit 100 is permitted, processing goes to step 511 and an inquiry request indicating that the access to the information inside the portable terminal unit 100 by the application processing is permitted is sent to the security agent 112 via the back end OS 121, the multi OS configuration part 130, and the front end OS 111.

Further, in the step 510, as a result of referring to the contents of the information access item read from the management policy 126, when the access to the information inside the portable terminal unit 100 is not permitted, processing goes to step 512 and an inquiry result indicating that the access to the information inside the portable terminal unit 100 by the application processing is not permitted is sent to the security agent 112 via the back end OS 121, the multi OS configuration part 130, and the front end OS 111.

In step 409, when the security agent 112 refers to an inquiry result returned from the security check processing part 124 and the inquiry result indicating that the access to the information inside the portable terminal unit 100 by the application processing is permitted is received, processing goes to step 410. In other cases, a message indicating the access to the information is not permitted is output to the output unit 104.

In the step 410, an access request to the information made by the application processing is made to the front end OS 111 and the access to the information is executed. The processing result is acquired from the front end OS 111 and is returned to the application.

On the other hand, in the step 406, as a result of checking the contents of an application processing request, the processing request is not an access request to the information inside the portable terminal unit 100, processing goes to step 411.

In the step 411, it is checked whether the contents of an application processing request made on the portable terminal unit 100 is a communication request to an external device of the portable terminal unit 100. If the communication request to the external device is assumed, processing goes to step 412.

In the step 412, a process ID of the application processing to which the processing request was made is acquired and a name of an application that corresponds to the process ID is read from the information about the process ID and the application name stored in the memory 102.

In step 413, the name of the read application is specified and an inquiry as to whether the communication processing with the external device of the portable terminal unit 100 by the application processing is permitted is sent to the security check processing part 124 via the front end OS 111, the multi OS configuration part 130, and the back end OS 121.

After the processing of the step 501, in the step 508, the security check processing part 124 checks the contents of an inquiry from the security agent 112. When the contents of the inquiry are not an inquiry as to whether the access to the information inside the portable terminal unit by application processing is permitted, processing goes to step 513.

In the step 513, the contents of an inquiry from the security agent 112 are checked. When the contents of the inquiry are an inquiry as to whether communication processing with the external device of the portable terminal unit 100 by application processing is permitted, processing goes to step 514.

In the step 514, an item of communication is read from a record of an AP name that matches a name of an application specified in the course of the inquiry referring to the management policy 126.

In step 515, when the contents of the item of the communication read from the management policy 126 are referred to and the communication processing with an external device of the portable terminal unit is permitted, processing goes to step 516 and an inquiry result indicating that the communication processing with the external device of the portable terminal unit 100 by the application processing is permitted is sent to the security agent 112 via the back end OS 121, the multi OS configuration part 130, and the front end OS 111.

In the step 515, as a result of referring to the contents of the item of the communication read from the management policy 126, when the communication processing with an external device of the portable terminal unit is not permitted, processing goes to step 517 and an inquiry result indicating that the communication processing with the external device of the portable terminal unit 100 by the application processing is not permitted is sent to the security agent 112 via the back end OS 121, the multi OS configuration part 130, and the front end OS 111.

In step 414, the security agent 112 refers to an inquiry result returned from the security check processing part 124, and when the inquiry result indicating the communication processing with an external device of the portable terminal unit 100 by the application processing is permitted is received, processing goes to step 415. In other cases, a message indicating that the communication processing with the external device is not permitted is output to the output unit 104.

In the step 415, a communication request to an external device made by the application processing is made to the front end 111 and the communication processing with the external device is executed. The processing result is acquired from the front end OS 111 and is returned to the application.

As described above, in the portable terminal unit 100 of this embodiment, the security agent 112 receives an application processing request made on the portable terminal unit 100, the security check processing part 124 determines whether the processing request is permitted in accordance with the management policy 126, and the portable terminal unit 100 provides a security function by executing application processing in accordance with the determination result. Accordingly, the security function suitable for a business application of a company that is the user can be provided by setting in the management policy 126 the information about the accessibility of the application based on a standard that differs from that of a common carrier.

In this embodiment, a security function for the effective period of an application, information access inside the portable terminal unit, and communication processing with an external device is described. The security function for another item such as specifying the effective period that differs every version of the application processing, setting accessibility data that differs in every information piece about directory data or schedule data of the portable terminal unit 100 and the accessibility data that differs in every content of access such as read, write, and deletion, and setting the accessibility data that differs in every URL of a communication destination can also be added.

Further, this security check processing and the management of the management policy 126 are performed under the control of the back end OS 121, which makes it unnecessary for the front end OS 111 to access the management policy 126 directly. Accordingly, even when a new security hole is detected in the latest front end OS 111, invalid access to the management policy 126 is prevented using the security hole and high security can be maintained. Further, if the processing of directly accessing the back end OS area 120 from the front end OS 111 is prohibited by specifying a different virtual memory space for the front end OS area 110 and the back end OS 120, higher security can be provided.

Further, in the portable terminal unit 100 of this embodiment, if a business application function is changed according to a change of contents of business, the management policy 126 of the portable terminal unit 100 can be maintained remotely by changing a management policy in the management processor 200 and updating the management policy 126 in the portable terminal unit 100 using the management policy up-data 125 in accordance with the contents of the management policy in the management processor 200.

FIG. 7 is a flowchart showing a processing procedure of the management policy up-data 125 of this embodiment. As shown in FIG. 7, the management policy up-data 125 of this embodiment updates the management policy 126 in the portable terminal unit in accordance with the contents of the management policy stored in the management processor 200.

In step 701, the management policy up-data 125 of the portable terminal unit 100 checks whether a predetermined condition under which the update processing of the management 126 starts is satisfied such as when predetermined time from the previous processing elapses or a special key is pressed by the user. If the condition is satisfied, processing goes to step 702.

In the step 702, a management policy acquisition destination URL indicating the latest management policy acquisition destination URL and an update date indicating a date when the management policy 126 was updated previously are read referring to the management policy 126 stored in the portable terminal unit 100.

In step 703, the management policy up-data 125 accesses the address of the management processor 200 indicated in the read management policy acquisition destination URL and requests the management processor 200 for the sending of the update information of the management policy stored in the management processor 200.

When the management processor 200 receives an acquisition request of the update information of a management policy, the management policy stored in the management processor 200 reads an update date that indicates the previously updated date and sends it to the portable terminal unit 100.

When the management policy up-data 125 of the portable terminal unit 100 receives the front end OS update information from the management processor 200, processing goes to step 704 and an update date read from the management policy 126 and an update date received from the management processor 200 are compared. When the update date of the management policy 126 stored in the portable terminal unit 100 is older, processing goes to step 705 assuming the update processing of the management policy 126 to be necessary.

In the step 705, a temporary stop instruction of processing is sent to the security check processing part 124 via the back end OS 121 and a temporary stop of the processing is instructed to the security check processing part 124.

When the security check processing part 124 receives the temporary stop instruction of the processing from the management policy up-data 125, the part terminates the security check processing being processed and subsequently enters a wait state in which a processing restart instruction is awaited.

In step 706, the management policy up-data 125 accesses the address of the management processor 200 indicated in the read management policy acquisition destination URL and requests the management processor 200 for the sending of the latest management policy data.

In step 707, the management policy up-data 125 receives management policy data sent from the management processor 200 and updates the management policy 126 to the latest state using the management policy data. In this process, an AP name indicated in the updated management policy 126 and a name of the user AP 114 stored in the front end OS area 110 are compared. When the information about the latest user AP not stored in the portable terminal unit 100 is contained in the updated management policy 126, the user AP 114 of the front end OS area 110 can also be updated by accessing the user AP distribution processor 300 and downloading the latest user AP. Further, when an application update instruction is provided in the updated management policy 126, the application update processing can also be performed here.

In step 708, a processing restart instruction is sent to the security processing part 124 via the back end OS 121 and processing restart is instructed to the security check processing part 124.

When the security processing part 124 receives a processing restart instruction from the management policy up-data 125, the security check processing that uses the updated management policy 126 can be performed.

As described above, in the portable terminal unit 100 of this embodiment, the remote maintenance of the user AP 114 and the management policy 126 inside the portable terminal unit 100 can be performed by changing a management policy inside the management processor 200 when a business application function is changed in accordance with a change of contents of business.

As described above, according to the portable terminal unit of this embodiment, if it is determined that a front end OS must be updated, the OS of the portable terminal unit can be performed efficiently because the front end OS is updated under the control of a back end OS.

Further, according to the portable terminal unit of this embodiment, because an application processing request permitted in accordance with a management policy is executed, a security function can be implemented by the portable terminal unit based on a standard unique to the user.

Further, according to the portable terminal unit of this embodiment, because a management policy inside the portable terminal unit is updated in accordance with the contents of the management policy stored in a management processor, the security function of the portable terminal unit can be maintained remotely.

According to the present invention, because a front end OS is updated under the control of a back end OS when it is determined that the front end OS must be updated, an OS of an information processor can be updated efficiently.

What is claimed is:

1. An OS (operating system) update method that updates an OS installed in an information processor, comprising the steps of:
determining whether an update of a front end OS that controls usual application processing is necessary;
terminating the processing of the front end OS in operation and switching the control of the information processor to a back end OS when it is determined that the update of said front end OS is necessary;
acquiring update data for updating the front end OS in the latest state under the control of the back end OS and updating the front end OS updated in the latest state; and
restarting the front end OS updated in said latest state.

2. The OS update method according to claim 1, wherein the data acquired or created under the control of the front end OS is stored in a different area from a storing area of the front end OS and the data acquired or created under the control of the front end OS before an update is reused under the control of the front end OS after an update.

3. The OS update method according to claim 1, wherein minimum necessary application processing is executed under the control of said switched back end OS.

4. A security control method that controls security of application processing executed in an information processor having a multi OS, comprising the steps of:
inquiring whether an application processing request made on the information processor is permitted when the application processing request is made;
responding to an inquiry result that indicates determination contents after determining whether said inquired processing request is permitted in accordance with a management policy; and
executing the application processing when the contents of said inquiry result indicate the execution permission of said application processing.

5. The security control method according to claim 4, wherein said management policy is managed under the control of an OS that differs from the OS to which the application processing request is made.

6. The security control method according to claim 4, wherein the management policy inside the information processor is updated according to the contents of the management policy stored in a management processor.

7. The security control method according to any one of claims 4, wherein said inquiry applies to whether or not said application program can be executed, whether or not information in a portable terminal unit can be accessed using said application, and whether or not communication with an external device is enabled.

8. An information processor that updates an OS installed in the information processor, comprising:
front end OS up-data that determines whether a front end OS that controls usual application processing must be updated, acquires update data for updating the front end OS in the latest state under the control of a back end OS, and updates the front end OS in the latest state; and
a multi OS configuration part that terminates processing of the front end OS in operation and switches control of the information processor to the back end OS, and then restarts the front OS updated in said latest state when it is determined that said front end OS must be updated.

9. An information processor that controls security of application processing executed in the information processor having a multi OS, comprising:
a security agent that sends to a security check processing part an inquiry as to whether an application processing request is permitted when the application processing request is made on the information processor and executes the application processing when contents of said inquiry result indicate the execution permission of said application processing; and
the security check processing part that responds to the security agent with an inquiry result that indicates determination contents after determining whether said inquired processing request is permitted in accordance with a management policy.

10. A method for updating the first OS in an information processor having the first OS that controls application processing and the second OS that is executed as a backend OS against the first OS, comprising:
determining whether an update of the first OS is necessary;
requiring to an destination relating to the first OS for acquiring an information regarding updating the first OS;
changing the control of the information processor to the second OS when the update of said first OS is necessary;
acquiring update information for the first OS under the control of the second OS; and
changing the control of the information processor to the first OS when the update information for the first OS is acquired.

11. The method according to claim 10, wherein the update information for the first OS is acquired via a network.

12. The method according to claim 10, wherein the information processor has a management table that stores at least time and destination address where the update information is acquired relating the first OS.

13. The method according to claim 10, wherein said determining step is executed by comparing management information of said first OS installed in the processor with the update information acquired from outside the processor.

14. The method according to claim 10, further comprising;
inquiring from the first OS to the second OS whether an application processing request made on the first OS in the information processor is permitted;
checking whether execution of the application inquired is effective or not under the control of the second OS; and
sending result of the checking from the second OS to the first OS.

15. The method according to claim 10, further comprising;
inquiring from the first OS to the second OS whether an access to information executed by an application processing made on the first OS in the information processor is permitted;
checking whether the access to the information executed by the application inquired is enable or not under the control of the second OS; and
sending result of the checking from the second OS to the first OS.

16. An information processor having a multi OS, comprising;
a memory having the first area for storing the first OS that controls application processing, the second area for storing the second OS that is executed as a backend when the first OS is at least updated and a multi OS configuration part that communicates between the first OS and the second OS;
a CPU for processing the application under the control of the first OS;
a communication unit that coupled the information processor to a network;
changing means for changing from the first OS to the second OS to control the information processor when the change of the first OS is necessary;
acquiring means for acquiring an updated information for the first OS via said communication unit under control of the second OS; and
means for operating the first OS vie said multi OS configuration part when the acquiring the updated information for the first OS is finished.

17. The processor according to claim 16, wherein said memory further has the third area for storing system data and an information table to store management information relating updating the first OS and is destination address of the acquiring the updated information.

18. The processor according to claim 16, further comprising; a security check processing part in the second area to check whether an application processing request made on the first OS is permitted and sends a result of the check from the first OS to the second OS.

19. The processor according to claim 18, further comprising;
a management policy in the second area under the control of the second OS to store information for an update instruction for the application, effective period and information access.

20. The processor according to claim 16, wherein said processor is a portable terminal unit that has an input unit for performing input operation and an output unit for performing output operation under the control at least of the first OS.
